(19) United States
(12) Patent Application Publication
(10) Pub. No.: US 2010/0264147 A1
(43) Pub. Date: Oct. 21, 2010

(54) Product packaging for one-component moisture-curing compositions

(76) Inventor: Eric Rosenthal, Long Beach, NY (US)

Correspondence Address: Eric Rosenthal, 336 Bayview Avenue, Amityville, NY, 11701, US

(21) Appl. No.: 12/386,316

(22) Filed: Apr. 16, 2009

(51) Int. Cl. B65D 41/04; B67B 3/20

(52) U.S. Cl. 220/288; 53/490

(57) ABSTRACT

Packaging for one-component moisture-curing compositions (and pre-packaged one-component moisture-curing compositions) is provided, and related methods. Such methods generally comprise providing a container with a desirable amount of a one-component moisture-curing composition. The container will preferably comprise a body portion, a spout, and a cap. According to certain embodiments, the spout will have a smaller diameter (or width) than the diameter (or width) of the body portion. In addition, the body portion will be comprised of a metallic material, whereas the cap will be comprised of a non-metallic material, such as plastic.

### FIELD OF THE INVENTION

The field of the present invention relates to methods of packaging one-component moisture-curing compositions and pre-packaged one-component moisture-curing compositions, such as paints, primers, rust preventive coatings, sealers, and polyurethane compositions (which may be clear or pigmented).

### BACKGROUND OF THE INVENTION

Polyurethane coatings are widely used in various applications, including for commercial, automotive and industrial protective coatings, as well as for use as decorative coatings on walls, floors and other surfaces. Moisture-curing polyurethane coatings are, for example, a highly desirable group of polyurethane coatings. Typical applications for such coatings include, but are not limited to, paints for prefabricated metal buildings, bridges, machinery, aircraft, vehicles, automotive parts, frames, chassis and chassis components, marine structures, ships, etc. The durable film exhibited by moisture cured polyurethane coatings forms a barrier that is resistant to moisture, oxygen, corrosion and damage to the coated surface.

These moisture-curing polyurethane coatings include adducts of diisocyanates or polyisocyanate/polyol combinations, with an excess of isocyanate groups (prepolymers) that chemically react and cross-link with atmospheric moisture at ambient or elevated temperatures to form insoluble high molecular weight polyurethanes/polyureas. Such properties cause these types of one-component moisture-curing compositions, e.g., polyurethane paints, to “glue” surfaces together. This “gluing” property often creates significant problems with the packaging that is used to house these types of compositions.

Specifically, one-component moisture-curing compositions are typically packaged and housed in traditional metal paint cans, which are well-known to have a generally cylindrical shape and a lid that is mechanically attached thereto through corresponding grooves located around the perimeter of the top side of the can and the perimeter of the lid. Once the traditional metal paint cans are opened, and a one-component moisture-curing composition is decanted therefrom and the lid is replaced and secured to the can, the lid often becomes “glued” and permanently bonded to the can. This often renders the lid unusable for future re-opening (and use of the constituent one-component moisture-curing composition difficult—if not impossible). Users of these one-component moisture-curing compositions, typically automotive restorers, automotive refinish and body collision professionals, and contractors performing industrial metal maintenance, sandblasting and refinishing, will often resort to punching holes in the paint cans to access the contents after they have mangled and almost destroyed the containers in an attempt to pry the “glued” lid from the can.

In view of the foregoing, a need exists for improved packaging containers, and methods of use thereof, for housing one-component moisture-curing compositions, such as paints, primers, rust preventive coatings, sealers, and polyurethane compositions.

### SUMMARY OF THE INVENTION

According to certain embodiments of the present invention, methods for packaging one-component moisture-curing compositions are provided. Such methods generally comprise providing a specialized container with a desirable amount of a one-component moisture-curing composition. In certain embodiments, the container will preferably comprise a body portion, a spout, and a cap. The body portion may be comprised of a metallic material, whereas the cap will, preferably, be comprised of a non-metallic material, such as plastic. According to certain embodiments, the spout of such containers is substantially narrower than the body portion, e.g., the spout has a diameter that is substantially smaller than the diameter of the body portion. The overall size (volume) of the container may vary, depending on the amount of one-component moisture-curing composition to be held. Non-limiting examples of such containers may be 8, 16, or 32 ounce containers or, in certain embodiments, the containers are 1-gallon containers with an extendable, non-metallic spout disposed in the top portion thereof.

According to additional embodiments of the present invention, pre-packaged one-component moisture-curing compositions are provided, which are packaged in the containers described herein. More particularly, a non-limiting example of such pre-packaged products may comprise a one-component moisture-curing composition housed in a container, which preferably includes a metallic body portion, a spout, and a non-metallic cap. As described herein, the spout of such containers will, preferably, be substantially narrower than the body portion thereof. Such pre-packaged one-component moisture-curing products may include, for example, one-component moisture-curing paints, primers, rust preventive coatings, sealers, or polyurethane compositions.

The above-mentioned and additional features of the present invention are further illustrated in the Detailed Description contained herein.

### BRIEF DESCRIPTION OF THE FIGURES

FIG. 1 is a drawing of a prior art container, which is regularly used to package conventional paints and one-component moisture-curing compositions.

FIG. 2 is a non-limiting example of a type of packaging (container) of the present invention that may be used to house one-component moisture-curing compositions, as described herein.

FIG. 3 is another non-limiting example of a type of packaging (container) of the present invention that may be used to house one-component moisture-curing compositions, as described herein.

FIG. 4 is top cross-sectional view of a cylindrical type of packaging (container) of the present invention that may be used to house one-component moisture-curing compositions, as described herein.

FIG. 5 is top cross-sectional view of a rectangular type of packaging (container) of the present invention that may be used to house one-component moisture-curing compositions, as described herein.

FIG. 6 is a perspective view of a 1-gallon container described herein, which comprises an extendable, non-metallic spout disposed in the top portion thereof.

### DETAILED DESCRIPTION OF THE INVENTION

The following will describe in detail several preferred embodiments of the present invention. These embodiments are provided by way of explanation only, and thus, should not unduly restrict the scope of the invention. In fact, those of ordinary skill in the art will appreciate upon reading the present specification and viewing the present drawings that the invention teaches many variations and modifications, and that numerous variations of the invention may be employed, used and made without departing from the scope and spirit of the invention.

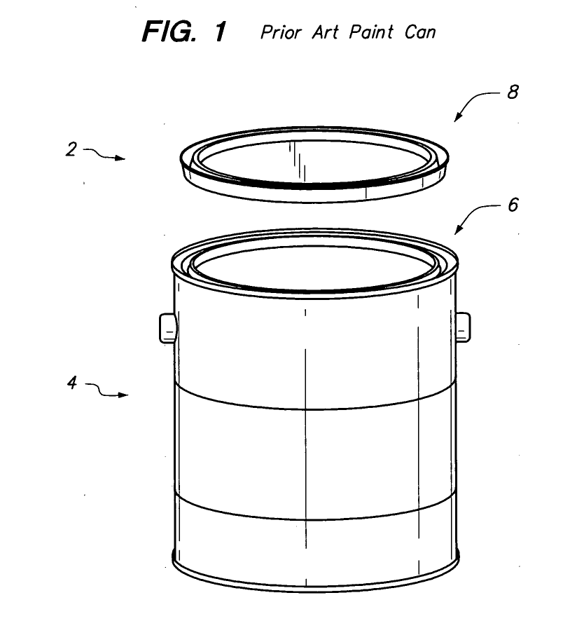

One-component moisture-curing compositions are typically packaged and housed in traditional metal paint cans. A non-limiting example of such traditional paint cans is shown in FIG. 1. As shown therein, these conventional paint cans typically comprise a lid 2 and a generally cylindrical body portion 4. The lid 2 is generally mechanically attached to the perimeter of the top side of the body portion 4, through corresponding grooves located around the perimeter of the top side of the can 6 and the perimeter of the lid 8. Once these conventional paint cans are opened, and a one-component moisture-curing composition is decanted therefrom, the lid 2 is replaced and secured to the body portion 4. After the can is allowed to sit for a period of time, the lid 2 often becomes “glued” and permanently bonded to the body portion 4 of the can. This often renders the paint can unusable for future re-opening. Future use of the constituent one-component moisture-curing composition is also made very difficult.

The foregoing problem is most apparent when cans containing one-component moisture curing compositions are opened for use, and small amounts of product spills into the “groove” 6 or “lip” on the top side of the traditional metal style paint can. After re-sealing the lid 2 to the body portion 4 of the can, the spilled product located in the groove 6 will serve to permanently bond the lid 2 to the body portion 4 of the can. This strength of the resulting bond can be considerable, requiring that the can be practically destroyed in order to access its contents. The present invention obviates many of the foregoing problems associated with using convention paint cans, such as the can shown in FIG. 1, to package one-component moisture-curing compositions.

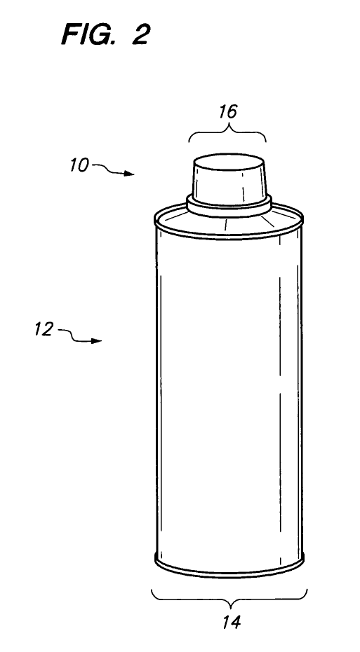

According to certain embodiments of the present invention, methods for packaging one-component moisture-curing compositions are provided. Such methods generally comprise providing a specialized container with a desirable amount of a one-component moisture-curing composition. Referring to FIG. 2, for example, in certain embodiments, the container will preferably comprise a body portion 12, a spout (not shown), and a cap 10. The body portion may be comprised of a metallic material or other suitable materials that will not chemically react with the constituent one-component moisture-curing compositions, such as certain materials comprised of polymers, elastomers, ceramics, metals, alloys, or combinations thereof. In certain preferred embodiments, however, the body portion 12 is comprised of a metallic material. The invention further provides that the cap 10 will, preferably, be comprised of a non-metallic material, such as plastics, polymers, elastomers, ceramics, or combinations thereof. In certain preferred embodiments, however, the cap 10 is comprised of a plastic material, such as a polyethylene plastic material.

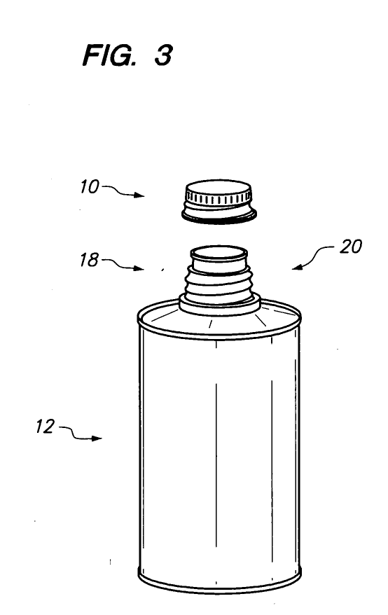

The invention provides that the cap 10 may be secured to the body portion 12 of the container using any suitable means. For example, referring to FIG. 3, the cap 10 may be reversibly screwed onto, and secured to, the spout 18 of the container. More particularly, for example, the cap 10 may comprise threaded portions on an interior surface thereof (not shown), which are capable of engaging a series of threads 20 located on the spout 18 of the container, such that the cap 10 may be reversibly screwed onto, and secured to, the spout 18 of the container. In certain alternative embodiments, the cap 10 may be secured to the body portion (or spout) of the container using other mechanical engagement means. For example, the cap 10 may be configured to reversibly “snap onto” the spout of the container. In such example, the cap 10 may comprise one or more engaging elements (not shown), which may be reversibly inserted into the spout, a portion thereof, and/or one or more apertures located therein, to reversibly secure the cap 10 to the spout. The invention provides that other means for mechanically and reversibly attaching the cap 10 to the spout of the container may be employed in the present invention.

According to certain embodiments, and referring to FIG. 2, the invention provides that the spout 16 of such containers is substantially narrower than the body portion 14. More particularly, for example, if the container exhibits a substantially cylindrical shape, the invention provides that the spout has a diameter 16 that is substantially smaller than the diameter 14 of the body portion 12. This aspect of the present invention is further illustrated in FIG. 4, which shows a top side, cross-sectional view of a cylindrically-shaped container that may be used to package one-component moisture-curing compositions in accordance with the present invention. As shown therein, the diameter of the spout 24 is smaller than the diameter 22 of the body portion. The invention provides that the diameter 22 of the body portion will preferably be at least 20% greater than the diameter of the spout 24 or, more preferably, at least 60% greater or, still more preferably, at least 100% greater.

According to additional embodiments of the present invention, the containers may comprise 1-gallon volumes, and include a non-metallic spout disposed in the top portion thereof. This embodiment is illustrated in FIG. 6. As with the other embodiments described herein, the spout portion will preferably be smaller than the diameter of the body portion of the container. The spout may also, optionally, be extendable, such that the spout may reversibly be extended when the one-component moisture-curing composition is poured, and then compressed back into the container when not in use.

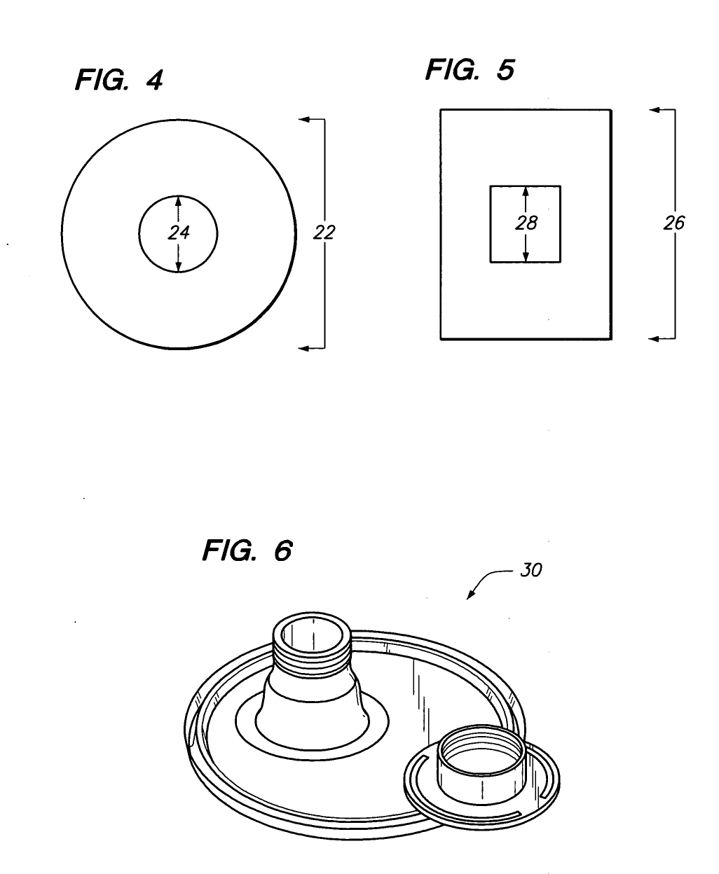

The invention provides that the containers described herein are not limited to cylindrically-shaped containers. Rather, subject to the other limitations described herein, the containers may exhibit any of a variety of regular or irregular shapes and configurations. Referring to FIG. 5, for example, the container may exhibit a substantially rectangular configuration. According to such embodiments, the spout will preferably comprise a width 28 that is smaller than the width 26 of the body portion. As used herein, the term “width” refers to the distance between the two most distant points of a top, cross-sectional portion of a spout, or a body portion, of a container. This is illustrated in FIG. 5, which shows the width of the spout 28 and the width of the body portion 26 of the container. As with the other embodiments described herein, the invention provides that the width of the body portion 26 will preferably be at least 20% greater than the width of the spout 28 or, more preferably, at least 60% greater or, still more preferably, at least 100% greater.

The invention further provides that the spout will, preferably, protrude outwards from the body portion of the container. In other words, although the spout of the container may comprise an aperture located in the top side of the container, the invention provides that a spout 18 will preferably protrude outwards and away from the body portion 12 of the container, e.g., as shown in FIG. 3.

When the spout is configured to be narrower than the body portion of the container, the one-component moisture-curing composition may be easily decanted therefrom. Next, given its relatively narrow configuration, and because the spout will preferably protrude outwards from the body portion of the container, the spout may be easily wiped clean with a towel, to remove any excess one-component moisture-curing composition. This will mitigate the possibility of the cap becoming glued to the spout. In addition, when the cap is comprised of, for example, a plastic material, the one-component moisture-curing composition will be less likely to create a strong bond between the plastic cap and, for example, a metal spout.

According to additional embodiments of the present invention, pre-packaged one-component moisture-curing compositions are provided, which are packaged in the containers described herein. More particularly, a non-limiting example of such pre-packaged products may comprise a one-component moisture-curing composition housed in a container, which preferably includes a metallic body portion, a spout, and a non-metallic cap. As described herein, the spout of such containers will, preferably, be substantially narrower than the body portion thereof.

The pre-packaged one-component moisture-curing compositions may include, for example, one-component moisture-curing paints, primers, rust preventive coatings, sealers, and polyurethane compositions—which may be clear or pigmented. These compositions may be pigmented, as desired, and additives (such as catalysts) may be incorporated to control composition properties, such as the time required for curing of the coating. A solvent, or a variety of solvents, may also be present in the coating to adjust viscosity and provide fluidity for proper application. The invention provides that such pre-packaged one-component moisture-curing compositions, which are packaged in the containers described herein, will preferably comprise one or more types of isocyanates, including, but not limited to, aliphatic polyisocyanates, diisocyanates, aromatic isocyanates, or combinations thereof.

It is to be understood that both the general description and the detailed description are exemplary and explanatory, but are not restrictive of the invention. The invention in its broader aspects is not limited to the specific details shown and described, and departures may be made from such details without departing from the principles of the invention and without sacrificing its chief advantages.

What is claimed is:

1. A method for packaging one-component moisture-curing compositions, which comprises the steps of providing a container with a desirable amount of a one-component moisture-curing composition, wherein the container comprises a body portion, a spout, and a cap comprised of a non-metallic material.

2. The method of claim 1, wherein the body portion comprises a diameter or width that is at least 20% greater than a diameter or width of the spout.

3. The method of claim 1, wherein the body portion comprises a diameter or width that is at least 60% greater than a diameter or width of the spout.

4. The method of claim 1, wherein the body portion comprises a diameter or width that is at least 100% greater than a diameter or width of the spout.

5. The method of claim 3, wherein the body portion is comprised of a metal and the cap is comprised of a plastic material.

6. The method of claim 5, wherein the cap is comprised of polyethylene plastic.

7. The method of claim 6, wherein the cap is threaded such that it may be reversibly connected to a spout having corresponding threads.

8. The method of claim 6, wherein the cap comprises one or more engaging elements which may be reversibly inserted into the spout, or a portion thereof, to reversibly secure the cap to the spout.

9. The method of claim 7, wherein the one-component moisture-curing-composition is selected from the group consisting of one-component moisture-curing paints, one-component moisture-curing sealers, one-component moisture-curing polyurethane, one-component moisture-curing primers, and one-component moisture-curing rust prevention coatings.

10. A method for packaging one-component moisture-curing compositions, which comprises the steps of providing a container with a desirable amount of a one-component moisture-curing composition, wherein the container comprises a body portion, a spout, and a cap, wherein the body portion comprises a diameter or width that is at least 20% greater than a diameter or width of the spout.

11. The method of claim 10, wherein the body portion comprises a diameter or width that is at least 60% greater than a diameter or width of the spout.

12. The method of claim 10, wherein the body portion comprises a diameter or width that is at least 100% greater than a diameter or width of the spout.

13. The method of claim 11, wherein the body portion is comprised of a metal and the cap is comprised of a polyethylene plastic material.

14. The method of claim 13, wherein the cap is threaded such that it may be reversibly connected to a spout having corresponding threads.

15. A pre-packaged one-component moisture-curing composition, which comprises a one-component moisture-curing composition housed in a container, wherein the container comprises a metallic body portion, a spout, and a cap comprised of a non-metallic material.

16. The pre-packaged one-component moisture-curing composition of claim 15, wherein the body portion comprises a diameter or width that is at least 60% greater than a diameter or width of the spout.

17. The pre-packaged one-component moisture-curing composition of claim 15, wherein the body portion comprises a diameter or width that is at least 100% greater than a diameter or width of the spout.

18. The pre-packaged one-component moisture-curing composition of claim 16, wherein the cap is comprised of a polyethylene plastic material.

19. The pre-packaged one-component moisture-curing composition of claim 18, wherein the cap is threaded such that it may be reversibly connected to a spout having corresponding threads.

20. The pre-packaged one-component moisture-curing composition of claim 19, wherein the one-component moisture-curing composition is selected from the group consisting of one-component moisture-curing paints, one-component moisture-curing sealers, one-component moisture-curing polyurethane, one-component moisture-curing primers, and one-component moisture-curing rust prevention coatings.
